(19) United States
(12) Patent Application Publication
(10) Pub. No.: US 2026/0238674 A1
(43) Pub. Date: Aug. 13, 2026

(54) SYSTEMS AND METHODS FOR VULNERABILITY ASSESSMENT IN AN ENTERPRISE ENVIRONMENT

(71) Applicant: Q2 Software, Inc., Austin, TX (US)

(72) Inventors: Clint Alan Lercher, Austin, TX (US); David Theodore Kludt, II, Austin, TX (US)

(21) Appl. No.: 19/532,380

(22) Filed: Feb. 6, 2026

Related U.S. Application Data
(60) Provisional application No. 63/755,927, filed on Feb. 7, 2025.

(51) Int. Cl. H04L 9/40

(52) U.S. Cl. CPC H04L 63/1433

(57) ABSTRACT

A system and method for contextualized vulnerability priority scoring receives vulnerability scan data identifying an event on an enterprise asset. The system and method determines multiple contextual attributes from scanning tools, asset inventory, and external sources. Predefined numeric risk values are assigned to each attribute with defaults for unknown values. The numeric values are aggregated and normalized by averaging to produce a risk score that is mapped to a discrete priority severity level. The priority severity level is output for remediation planning. Manual adjustments are supported for contexts.

### CROSS-REFERENCE TO RELATED APPLICATION(S)

This application is a continuation of and claims a benefit of priority under 35 U.S.C. 120 from U.S. Patent Application No. 63/755,927, filed Feb. 7, 2025, entitled “SYSTEMS AND METHODS FOR VULNERABILITY ASSESSMENT IN AN ENTERPRISE ENVIRONMENT,” which is fully incorporated by reference herein for all purposes.

### TECHNICAL FIELD

This disclosure relates generally to computing systems for prioritizing vulnerability remediation in an enterprise environment based on contextual attributes of a vulnerability.

### BACKGROUND

In computing and software environments, it is advantageous to fix weaknesses that can be used by attackers to gain unauthorized access or cause harm. These weaknesses, also known as vulnerabilities, may exist in hardware, software, or processes anywhere in a computing system or a computing network. For small networks, it may be feasible for an administrator to address vulnerabilities as they are reported. However, as a network grows in scale and complexity, vulnerabilities become too numerous to address in a timely or cost-effective manner.

Vulnerabilities can exist in different operating systems and applications. Vulnerabilities may be published for public disclosure as they are discovered. The Common Vulnerabilities and Exposures (CVE) list maintained by the MITRE Corporation and the National Vulnerability Database (NVD) provide identifiers and basic information for publicly known vulnerabilities.

The Common Vulnerability Scoring System (CVSS) is a standardized framework used to assess and communicate the severity of a security vulnerability. A CVSS score, typically ranging from 0 to 10, is assigned to a vulnerability based on a fixed set of metrics evaluated at a single point in time. While CVSS provides a useful baseline severity rating, it does not account for organization-specific factors such as the business role of the affected asset, its exposure to the internet, the type of data it processes, or real-world exploitation activity. Consequently, two identical CVEs on different assets within the same enterprise may present substantially different actual risks while receiving identical CVSS treatment.

Existing vulnerability management tools primarily rely on CVSS or tool-specific severity ratings, which can lead to misallocation of remediation resources. High-volume medium-severity findings may overwhelm teams, while truly critical contextual risks may be deprioritized. This inefficiency increases the window of exposure for the enterprise, consuming unnecessary computational and human resources on lower-risk items.

### SUMMARY OF THE DISCLOSURE

Embodiments of the subject disclosure provide systems and methods for contextualized vulnerability priority scoring. The scoring incorporates organization-specific asset and environmental attributes with vulnerability characteristics, producing a normalized priority score. The resulting priority score more accurately reflects actual risk to the enterprise, enabling efficient allocation of remediation resources.

By integrating data from multiple scanning tools, asset inventory systems, and external exploit intelligence sources, the disclosed embodiments transform raw vulnerability findings into contextualized priority ratings. The specific combination of attributes, scoring rules, handling of unknown values, and subset relationships provides a technical solution that improves the operation of vulnerability management systems by directing processing and analyst effort toward vulnerabilities that present the greatest threat to enterprise assets.

The disclosed embodiments reduce unnecessary computation on low-context findings and accelerate remediation of high-context risks, thereby enhancing computational resource utilization within the enterprise computing environment. The ordered pipeline of data ingestion from diverse sources, multi-attribute enrichment, subset-aware aggregation, and average-based normalization produces a unified risk metric. The unified risk metric enables direct comparison and prioritization of vulnerability instances across different assets.

One embodiment comprises a method performed by a computing system having at least one processor and memory. The method comprises receiving scan data identifying a CVE on an asset, determining values for a plurality of contextual attributes, assigning predefined numeric risk values with defaults for unknown data, aggregating while avoiding double-counting through subset suppression, normalizing by averaging, mapping to a priority severity level, and outputting the priority severity level.

Further embodiments include systems configured with modules to perform the above steps and non-transitory computer-readable media storing instructions that, when executed by one or more processors, cause the system to perform the method.

### BRIEF DESCRIPTION OF THE DRAWINGS

FIG. 1 is a block diagram depicting an embodiment of a system for contextualized vulnerability priority scoring.

FIG. 2 is a flow diagram of a method for generating a contextualized priority score according to one embodiment.

FIG. 3 is a diagram illustrating the contextual attributes, their data sources, and scoring assignments.

FIG. 4 is a diagram showing attribute subset relationships and suppression logic.

FIG. 5 is a diagram of an example priority score calculation for a specific vulnerability instance.

FIG. 6 depicts a user interface dashboard displaying vulnerabilities ordered by contextual priority score.

### DETAILED DESCRIPTION

Embodiments of the present disclosure are described herein with reference to the accompanying drawings. The system processes vulnerability scan data in conjunction with asset context to produce normalized priority scores that reflect enterprise-specific risk.

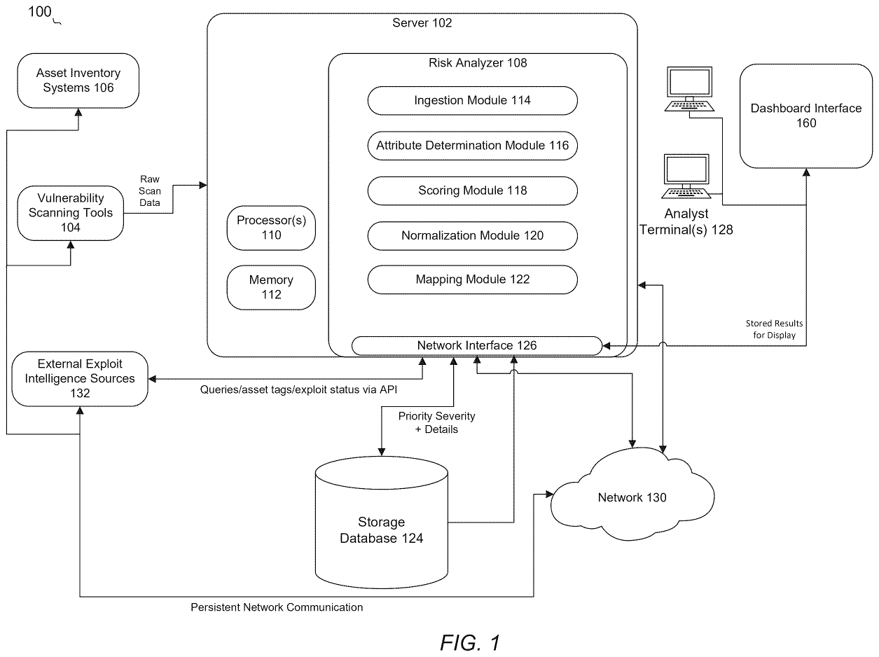

FIG. 1 is a block diagram depicting an embodiment of a system 100 for contextualized vulnerability priority scoring. The system 100 comprises a risk analyzer 108 (also referred to as the priority scoring engine) that executes on one or more servers 102 equipped with processors 110 and memory 112. The risk contextual analyzer 108 receives raw scan data from vulnerability scanning tools 104 and outputs contextualized data that reflects enterprise-specific risk.

The risk analyzer 108 contains an application programming interface (API) layer that enables secure communication over a network 130. Through this API layer, the analyzer 108 connects to multiple external data sources, including third-party management platforms that maintain inventory and tagging information for organization assets. These connections allow the risk analyzer 108 to retrieve real-time contextual details about each affected asset.

The ingestion module 114 within the risk analyzer 108 first receives and parses scan data from scanning tools 104 (e.g., Tenable, Wiz). The ingestion module 114 normalizes differing formats and severity designations from multiple tools, extracting CVE identifiers, tool-specific severity ratings, attack vector information, and initial exploitation indicators.

Once the scan data is normalized and stored temporarily in memory 112, attribute determination module 116 uses the API layer to query asset inventory systems 106 (e.g., Infraray, Jamf) for asset-specific tags. These tags can include public exposure status, environment classification, and customer data presence. The attribute determination module 116 also queries external exploit intelligence sources 132, such as the CISA Known Exploited Vulnerabilities catalog, to retrieve current exploitation status.

After all available attribute values are collected and held in memory 112, the scoring module 118 assigns predefined numeric risk values to each attribute. The scoring module 118 applies “worst case” high-risk defaults to any null or unknown values, ensuring the system errs on the side of caution. The scoring module 118 then aggregates the numeric values while applying subset suppression logic to prevent double-counting of overlapping risk factors.

The normalization module 120 divides the aggregated total by the number of populated attributes to produce an average risk score that is comparable across vulnerability instances with differing numbers of available attributes. The mapping module 122 applies predefined thresholds to convert the average risk score into a discrete priority severity level (P0 through P4). The resulting priority severity level, together with the supporting attribute details and average risk score, is stored in storage database 124 and presented via dashboard interface 160 on analyst terminals 128.

The network interface 126 and associated API layer maintain persistent, secure connections to scanning tools 104, asset inventory systems 106, third-party management platforms, and external intelligence sources 132. The processors 110 coordinate execution of the modules 114, 116, 118, 120, and 122 in a pipeline that processes each incoming vulnerability record efficiently. This structured, multi-source enrichment and scoring pipeline executed by the risk contextual analyzer 108 transforms diverse raw scan data into actionable, contextually accurate priority ratings across the entire population of organization assets.

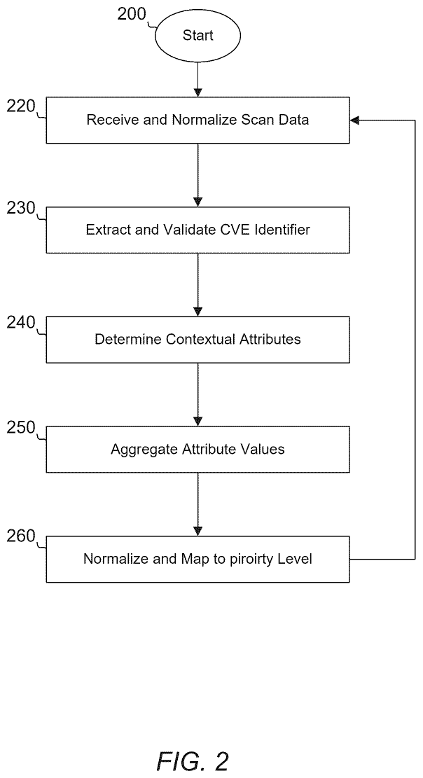

FIG. 2 is a flow diagram of a method 200 for generating a contextualized priority score according to one embodiment. The diagram includes a sequence of primary processing blocks 220, 230, 240, 250, 260 connected by arrows that indicate the ordered operational flow within the risk contextual analyzer. A return arrow 270 loops from the completion of block 260 back to block 220 to represent continuous processing of incoming scan data.

The method 200 begins at step 220, where the risk contextual analyzer receives scan data identifying a vulnerability and the affected asset from one or more scanning tools. The scan data arrives at step 220 where the ingestion module parses the incoming records and normalizes differing formats from multiple scanning tools.

The flow continues to step 230 where the CVE identifier is extracted and validated from the scan data held in memory. Step 230 ensures that all subsequent attribute retrieval and scoring operations are associated with the correct vulnerability identifier.

The flow proceeds to step 240 where the attribute determination module determines one or more contextual attribute values based on the affected asset and available data sources. At 240, the risk contextual analyzer issues multiple queries through the API layer to scanning tools, asset inventory systems, third-party management platforms, and external exploit intelligence sources to populate attributes. These attributes comprise tool severity, exploitation indicators, attack vector, public exposure status, environment classification, and customer data presence.

The flow continues to step 250 where the scoring module aggregates the contextual attribute values. At step 250, predefined numeric risk values are assigned to each populated attribute. Also, subset suppression logic is applied. Block 250 operates on the in-memory attribute set collected during step 240 to produce a single aggregated numeric total. The method 200 prevents double-counting of related risk factors.

The flow advances to step 260 where the normalization module normalizes the aggregated total. Block 260 divides the total by the count of populated attributes, to yield an average risk score that is stored in memory. Step 260 produces a unified and comparable risk metric that accounts for varying amounts of available attribute data across different assets and vulnerability instances.

After step 260 completes normalization, the mapping module applies predefined thresholds to convert the average risk score into a discrete priority severity level. The priority severity level is then output for storage in database 124 and display on dashboard interface 160. At 270, a return arrow is provided that routes the risk contextual analyzer back to block 220 so that the next incoming scan data record can begin processing without delay.

The sequence of steps 220-260 executes on the processors of the server hosting the risk contextual analyzer for a vulnerability instance. Each of steps 220, 230, 240, 250, 260 represents coordinated operations among the ingestion, attribute determination, scoring, normalization, and mapping modules, with data passing sequentially from one block to the next until the return arrow 270 restarts the cycle.

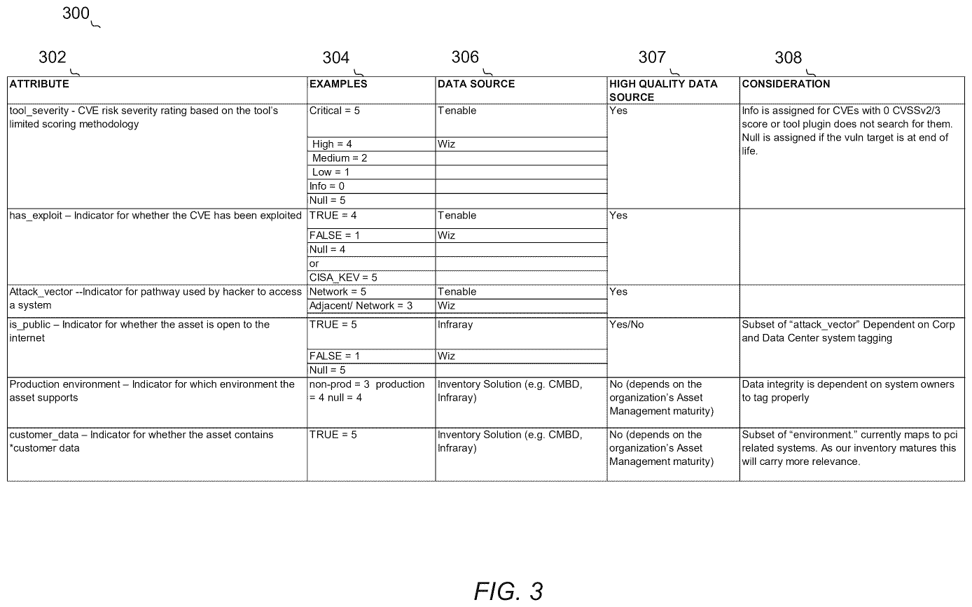

FIG. 3 is a diagram 300 illustrating the contextual attributes, their data sources, and scoring assignments. The diagram 300 presents the attributes in a structured tabular format with defined columns for attribute name 302, example values and corresponding numeric risk scores 304, primary data sources 306, high-quality indicator 307, and additional considerations 308. Each row in the table corresponds to one contextual attribute used by the risk contextual analyzer (FIG. 1).

The first row in diagram 300 details the tool_severity attribute with scoring assignments of 5 for critical or null, 4 for high, 2 for medium, 1 for low, and 0 for informational. These scoring assignments are sourced from scanning tools marked as high-quality in column 307. Subsequent rows systematically present the remaining attributes in the same tabular structure. The has_exploit attribute row shows scores of 4 for true or null and 1 for false, also sourced from scanning tools with high-quality designation as shown in column 307.

The cisa_kev_exploit attribute row in diagram 300 assigns a score of 5 when true, sourced exclusively from the external CISA Known Exploited Vulnerabilities catalog marked as high-quality. The attack_vector attribute row lists scores of 5 for network, 3 for adjacent, and 1 for local or physical, obtained from scanning tools. The is_public attribute row assigns 5 for true or null and 1 for false, with sources including both scanning tools and asset inventory systems.

Continuing in sequence, the environment attribute row in diagram 300 scores production as 4, non-production as 3, and null as 4. These scores are sourced from the asset inventory system. The final customer_data attribute row assigns 5 when true and is also sourced from asset inventory. Consideration column 308 highlights subset relationships and data quality notes for each attribute.

The tabular layout of diagram 300 provides reference that the risk contextual analyzer consults during attribute assignment and scoring. Each cell in columns 304, 306, 307, and 308 contains the values and metadata applied by the scoring module when processing a vulnerability record.

The structured rows and columns 302, 304, 306, 307, 308 in diagram 300 facilitate lookup and consistent application of scoring rules across all assets and vulnerability instances. The comprehensive presentation in diagram 300 ensures traceability from raw attribute values to their numeric contributions in the final priority score.

The inclusion of high-quality indicators 307 and consideration notes 308 within the same tabular structure of diagram 300 supports operational decision-making regarding data reliability and subset suppression logic during execution.

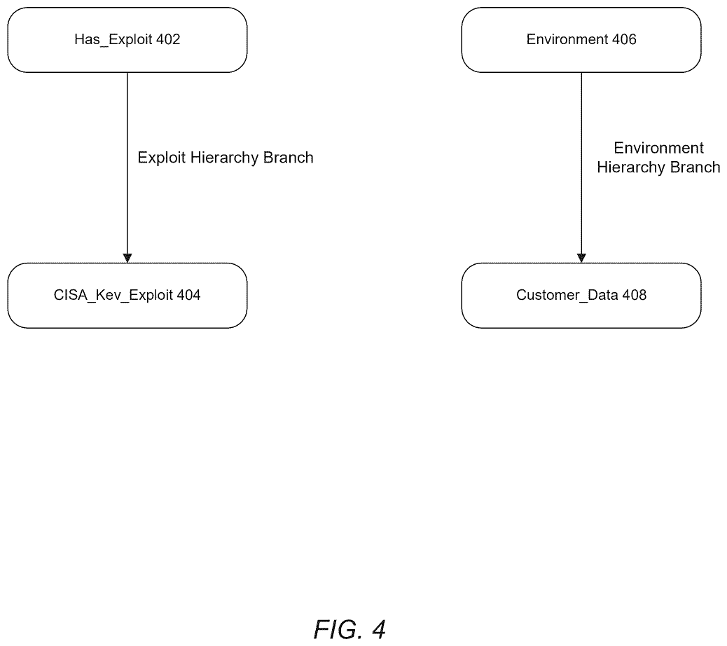

FIG. 4 is a diagram 400 showing attribute subset relationships and suppression logic. The diagram 400 depicts hierarchical connections between superset and subset attributes using directed arrows. A primary branch connects has_exploit 402 to its subset cisa_kev_exploit 404, with a suppression indicator when the subset cisa_kev_exploit 404 is populated.

A parallel branch in diagram 400 connects environment 406 to its subset customer_data 408, similarly marked for suppression of the superset contribution when customer_data 408 is available.

The hierarchical structure in diagram 400 illustrates the non-weighted aggregation approach that prioritizes more specific contextual information. Suppression arrows in diagram 400 represent the prevention of double-counting with respect to related risk factors during score calculation.

The relationships in diagram 400 are stored and consulted by the scoring module to apply correct aggregation logic. When cisa_kev_exploit 404 is true, the has_exploit 402 value is omitted per the suppression rule shown in diagram 400. Similarly, population of customer_data 408 triggers omission of environment 406 contribution as indicated in diagram 400. The fixed relationships ensure reproducible priority scores across assets.

The diagram 400 serves as operational documentation of the specific technical arrangement for handling overlapping attribute information. The arrows and indicators in diagram 400 guide the suppression process executed by instructions of the scoring module.

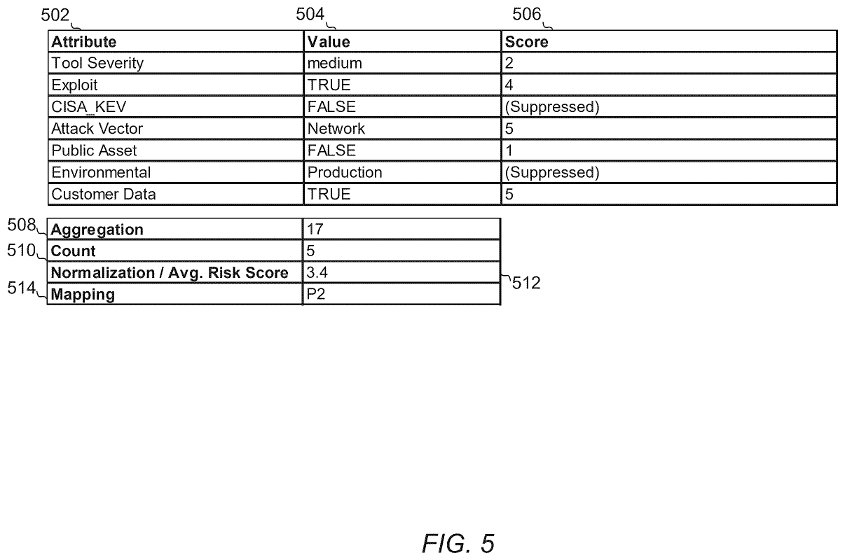

FIG. 5 is a diagram 500 of an example priority score calculation for a specific vulnerability instance. The diagram 500 presents a column of attributes 502 alongside their determined values 504 and assigned numeric scores 506. Populated attributes comprise tool_severity: medium (2), has_exploit: true (4), attack_vector: network (5), is_public: false (1), and customer_data: true (5).

Suppressed attributes in diagram 500 are marked to show application of subset logic, omitting contributions from cisa_kev_exploit false and environment production. The remaining scores sum to 17 in an aggregation box 508 within diagram 500.

A count box 510 in diagram 500 indicates five populated attributes. Normalization division 17 by 5 yields 3.4 in result box 512 of diagram 500. A mapping section 514 applies thresholds to assign P2 priority severity to the calculated average. This assignment is based on the following table for Priority Score designation:

| risk_score | risk_severity | SLA |
|---|---|---|
| >=5 | P0 (zero-day/weaponized) | Per Incident Response Process |
| 4.0-<5.0 | P1 | 10 days |
| 3.0-<4.0 | P2 | 30 days |
| 2.0-<3.0 | P3 | 100 days |
| 1.0-<2.0 | P4 | Discretionary |

The step-by-step layout in diagram 500 show the internal processing sequence from attribute assignment through normalization and mapping. The example values 504 and scores 506 in diagram 500 demonstrate handling and subset suppression.

The numerical progression shown in boxes 508, 510, 512, and 514 of diagram 500 provides illustration of how different contextual combinations produce distinct priority outcomes. The diagram 500 enables traceability from raw attribute values to final priority severity. The example in diagram 500 highlights differentiation of identical CVEs based on asset context.

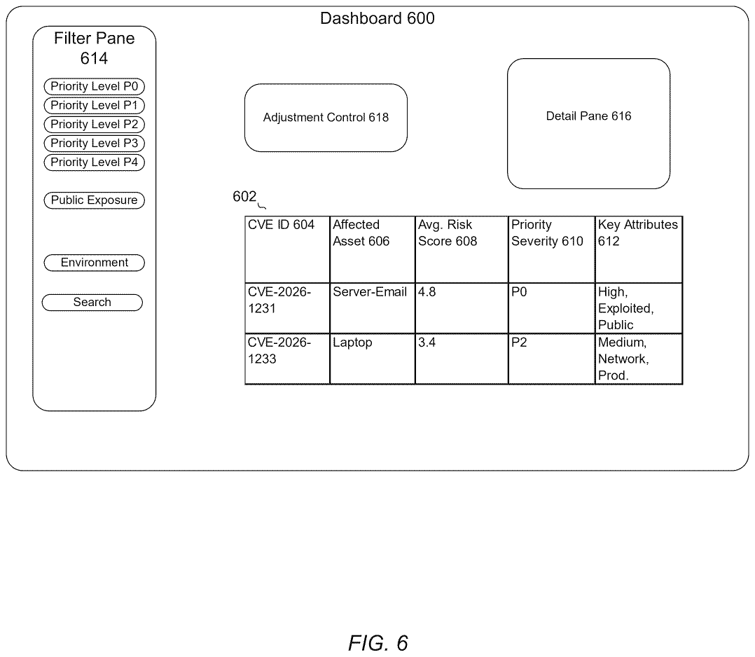

FIG. 6 depicts a user interface dashboard 600 displaying vulnerabilities ordered by contextual priority score. The dashboard 600 includes a sortable table 602 with columns for CVE identifier 604, affected asset 606, average risk score 608, priority severity 610, and key attributes 612. Rows in table 602 are ordered by average risk score 608, positioning highest contextual risk at the top.

A filter panel 614 allows selection by priority level or attribute values on dashboard 600. Row selection expands a detail pane 616 showing full attribute breakdown and numeric contributions for the selected vulnerability in dashboard 600. An adjustment control 618 in the detail pane 616 enables authorized users to apply manual overrides when warranted by additional context. The dashboard 600 renders in real time on user terminals connected to the risk contextual analyzer.

The ordered presentation in table 602 facilitates identification of remediation targets. The interface elements 602, 614, 616, and 618 integrate computed scores into operational workflows on dashboard 600. Transparent detail expansion of detail pane 616 supports review activities within dashboard 600. Visual prioritization in table 602 reduces analyst effort compared to uncontextualized lists. The real-time updates reflect changes from new scans or manual adjustments on dashboard 600.

The system further supports manual adjustment of priority scores when additional context becomes known outside automated attribute collection. Authorized users access the adjustment control on the dashboard interface to propose modifications based on factors such as confirmed mitigations or emerging threat intelligence.

Proposed adjustments trigger a review workflow requiring security team approval before application. Upon approval, the system updates the affected priority score, stores adjustment rationale in the database, and refreshes dashboard displays. This capability preserves the benefits of automated contextual scoring while accommodating exceptional cases through structured human oversight.

The priority severity levels produced by the mapping module provide actionable categories aligned with remediation service level agreements. Average risk scores of 5.0 or higher map to P0 severity, triggering immediate engagement of the incident response process. Scores from 4.0 to 4.9 map to P1 severity, typically associated with aggressive remediation timelines such as ten days under updated organizational objectives.

Scores from 3.0 to 3.9 correspond to P2 severity, with remediation timelines such as thirty days, while scores from 2.0 to 2.9 map to P3 severity with extended periods such as one hundred days. Scores below 2.0 fall into P4 severity, allowing discretionary handling. This tiered mapping enables consistent, risk-based allocation of remediation resources across large asset populations.

In operation across enterprise-scale environments containing thousands of assets and vulnerability instances, the risk contextual analyzer processes incoming scan data continuously. The efficient pipeline minimizes latency between scan ingestion and priority score availability, allowing security teams to act on intelligence before exploitation opportunities arise.

The combination of automated multi-source attribute enrichment, default handling, subset-aware non-weighted aggregation, and average normalization produces priority scores that more accurately reflect actual business risk than traditional severity-only approaches. By elevating vulnerabilities on critical assets and deprioritizing those on low-risk systems, the system directs limited analyst and computational resources to findings that most impact enterprise security.

The structured manual adjustment workflow preserves auditability while accommodating exceptional circumstances not captured by automated attributes. All adjustments are logged with rationale in database 124, enabling retrospective analysis and continuous refinement of scoring rules.

Overall, the disclosed systems and methods provide a technical advancement in vulnerability management by transforming heterogeneous, tool-specific scan output into normalized, contextually accurate priority ratings that improve remediation efficiency, reduce exposure windows for high-risk vulnerabilities, and optimize utilization of enterprise security resources.

Embodiments as described herein are merely illustrative, and not restrictive of the invention. Thus, embodiments may also be understood with reference to the enclosed Appendix, where it will be noted that any restrictive language included therein should be taken as applying only to those example embodiments.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can be executed on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

To the extent particular values are provided in any example embodiments in the description, such values are provided by way of example and not limitation. Moreover, while in some embodiments rules may use hardcoded values, in other embodiments rules may use flexible values. In one embodiment, one or more of the values may be specified in a registry, allowing the value(s) to be easily updated without changing the code. The values can be changed, for example, in response to analyzing system performance.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A method for contextualized vulnerability priority scoring in an enterprise environment, the method performed by a computing system having at least one processor and a memory, the method comprising:
receiving scan data identifying a vulnerability and an affected asset, the scan data including a Common Vulnerabilities and Exposures (CVE) identifier;
determining values for a plurality of contextual attributes by querying at least one asset inventory system and at least one external exploit intelligence source via an application programming interface (API) layer;
assigning, by the at least one processor, a predefined numeric risk value to each of the plurality of contextual attributes, wherein a default high-risk numeric value is assigned to any contextual attribute having a null value;
aggregating the assigned numeric risk values to produce an aggregated total, wherein subset suppression logic is applied to omit a numeric risk value of a superset attribute when a corresponding subset attribute is populated;
normalizing the aggregated total by dividing the aggregated total by a count of populated contextual attributes to produce an average risk score;
mapping the average risk score to a priority severity level based on predefined thresholds; and
outputting the priority severity level to a dashboard interface for remediation.

2. The method of claim 1, wherein the plurality of contextual attributes comprises tool severity, exploitation status, attack vector, public exposure status, environment classification, and customer data presence.

3. The method of claim 1, wherein applying the subset suppression logic comprises omitting a numeric risk value for a general exploitation attribute when a subset Known Exploited Vulnerabilities (KEV) attribute is populated.

4. The method of claim 1, wherein applying the subset suppression logic comprises omitting a numeric risk value for an environment classification attribute when a subset customer data presence attribute is populated.

5. The method of claim 1, further comprising:
receiving a proposed manual adjustment to the priority severity level via the dashboard interface; and
updating the priority severity level only upon electronic approval of a review workflow.

6. The method of claim 1, wherein the predefined thresholds map the average risk score to a scale of P0 through P4, wherein a score of 5.0 or higher maps to P0 and triggers an incident response process.

7. The method of claim 1, wherein receiving the scan data further comprises normalizing differing formats and severity designations from a plurality of distinct vulnerability scanning tools.

8. A system for contextualized vulnerability priority scoring in an enterprise environment, comprising:
at least one processor;
a memory communicatively coupled to the at least one processor and storing vulnerability scoring logic that, when executed by the at least one processor, configures the system to:
parse incoming scan data identifying a vulnerability and an affected asset to extract a Common Vulnerabilities and Exposures (CVE) identifier;
retrieve contextual attribute values by querying at least one asset inventory system and at least one external exploit intelligence source;
assign a predefined numeric risk value to each contextual attribute, including assigning a default high-risk numeric value to any attribute having a null value;
calculate an aggregated total by applying subset suppression logic that omits a numeric risk value of a superset attribute when a corresponding subset attribute is populated;
generate an average risk score by dividing the aggregated total by a count of populated contextual attributes; and
assign a priority severity level based on the average risk score for output to a dashboard interface.

9. The system of claim 8, wherein the plurality of contextual attributes comprises tool severity, exploitation status, attack vector, public exposure status, environment classification, and customer data presence.

10. The system of claim 8, wherein the subset suppression logic comprises instructions to omit a numeric risk value for a general exploitation attribute when a subset Known Exploited Vulnerabilities (KEV) attribute is populated.

11. The system of claim 8, wherein the subset suppression logic comprises instructions to omit a numeric risk value for an environment classification attribute when a subset customer data presence attribute is populated.

12. The system of claim 8, wherein the vulnerability scoring logic further configures the system to:
receive a proposed manual adjustment to the priority severity level; and
update the priority severity level upon approval of a review workflow.

13. The system of claim 8, wherein the priority severity level is assigned according to thresholds where a score of 5.0 or higher maps to P0.

14. The system of claim 8, wherein the vulnerability scoring logic further configures the system to normalize differing formats from a plurality of distinct vulnerability scanning tools.

15. A non-transitory computer-readable medium storing instructions that, when executed by one or more processors, cause the one or more processors to perform a method comprising:
receiving scan data identifying a vulnerability and an affected asset;
determining values for a plurality of contextual attributes by querying an asset inventory system and an external exploit intelligence source;
assigning a predefined numeric risk value to each of the plurality of contextual attributes, wherein a default high-risk numeric value is assigned to any contextual attribute having a null value;
aggregating the assigned numeric risk values to produce an aggregated total, wherein subset suppression logic is applied to omit a numeric risk value of a superset attribute when a corresponding subset attribute is populated;
normalizing the aggregated total by dividing the aggregated total by a count of populated contextual attributes to produce an average risk score;
mapping the average risk score to a priority severity level; and
outputting the priority severity level.

16. The non-transitory computer-readable medium of claim 15, wherein the plurality of contextual attributes comprises tool severity, exploitation status, attack vector, public exposure status, environment classification, and customer data presence.

17. The non-transitory computer-readable medium of claim 15, wherein applying the subset suppression logic comprises omitting a numeric risk value for a general exploitation attribute when a subset Known Exploited Vulnerabilities (KEV) attribute is populated.

18. The non-transitory computer-readable medium of claim 15, wherein applying the subset suppression logic comprises omitting a numeric risk value for an environment classification attribute when a subset customer data presence attribute is populated.

19. The non-transitory computer-readable medium of claim 15, the method further comprising updating the priority severity level in response to a manual override and a review workflow.

20. The non-transitory computer-readable medium of claim 15, wherein the mapping to a priority severity level is based on thresholds where an average risk score of 5.0 or higher triggers an immediate incident response protocol.
